(19) United States
(12) Patent Application Publication
(10) Pub. No.: US 2026/0309852 A1
(43) Pub. Date: Oct. 8, 2026

(54) PARENT VEHICLE WITH LASER DISTANCE DETECTOR ASSEMBLY FOR TRANSPORTING A SATELLITE VEHICLE FOR AUTOMATICALLY STORING A LOAD, POSITION DETECTION METHOD, AND AUTOMATED WAREHOUSE

(71) Applicant: AUTOMHA S.P.A., Azzano San Paolo (Bergamo) (IT)

(72) Inventor: Walter DANNE, Azzano San Paolo (Bergamo) (IT)

(21) Appl. No.: 19/476,455

(22) PCT Filed: Apr. 19, 2024
(86) PCT No.: PCT/IB2024/053819

§ 371 Date: Oct. 17, 2025

(30) Foreign Application Priority Data
Apr. 20, 2023 (IT) 102023000007779

(51) Int. Cl. G01S 7/497; B65G 1/04; G01S 17/08

(52) U.S. Cl. CPC G01S 7/4972; B65G 1/0492; G01S 17/08

(57) ABSTRACT

A parent vehicle for transporting a satellite vehicle for automatically storing a load in a warehouse has a base frame onto which wheels of the parent vehicle are rotatably connected, and a distance detector assembly having a laser device configured to emit a laser beam and detect a time of flight of the laser beam to generate a distance signal. The distance detector assembly has a tilt detection device and a laser device actuator operatively connected to the laser device to move the laser device. An electronic processing unit is configured to receive a parent vehicle tilt signal from the tilt detection device and to generate a control signal for the laser device actuator to move the laser device with respect to the base frame to compensate for a tilt of the parent vehicle detected by the tilt detection device.

### FIELD OF APPLICATION

The present invention falls within the field of the production of automated systems for the storage of items on pallets in an automated warehouse.

In particular, the present invention relates to a parent vehicle for transporting a satellite vehicle for automatically storing a load, in particular for storing and moving pallets containing items for automated warehouses. Furthermore, the present invention also relates to a method for detecting a relative position of a parent vehicle and an automated warehouse which comprises a parent vehicle and is capable of performing the aforesaid method.

### Prior Art

Automated warehouses structured to allow the automatic storage of pallets are known in the art.

From a design point of view, these warehouses normally employ load-bearing structures comprising a structure with shoulders and uprights that defines a plurality of storage aisles of variable dimensions according to the foreseen loads. The pallets are arranged and picked up along/from such aisles through automated devices, called satellites or shuttles. In practice, these devices deposit, automatically and in series, a plurality of pallets on support guides arranged along the storage aisle. In more detail, this deposit normally takes place starting from one end of an aisle or in any case from the first free position identified within the aisle itself.

In order to perform the operations for which it is intended, the satellite normally comprises a frame provided with a plurality of wheels so as to allow the satellite to be moved along the storage aisle.

These wheels are actuated by suitable handling means which generally consist of electric motors, which are operatively controlled by command and control means and which are powered by suitable power supply means, such as batteries.

The Satellite further comprises two distinct sections suitable for providing a support surface for the pallet, as well as position detection means suitable for determining the position of the satellite in one or more points of the aisle, or means for detecting the position in a continuous manner, for example by means of laser position detection systems.

The satellite is powered by suitable on-board batteries or supercapacitors and their recharging may take place during the period in which the satellite is positioned in a further shuttle, also known as a transport parent vehicle. In particular, the parent vehicle is moved along transfer aisles, arranged transversely to the storage aisles, and houses or releases from time to time the satellites coming from the storage aisles for transporting the pallets to and from the storage aisles. An example of such type of warehouse, parent vehicle, and satellite vehicle is described in document WO2012127419A1.

Typically, therefore, the parent vehicle moves on a dedicated track and has the task of positioning itself along this track with millimeter accuracy at the center of the access mouth to the storage aisle.

In the prior art, there are different types for detecting the position of the parent vehicle, both odometric and optical.

One of these types provides for the use of time-of-flight laser distance detectors with respect to a fixed reflector generally placed on the transfer aisle.

However, given that the parent vehicle and satellite vehicle systems move on multi-level warehouses (where at each level it rests on the underlying level), it follows that, given the natural bending that the structural parts of the tracks and of the warehouse shelf may undergo, the tracks placed at different levels do not ensure perfect flatness during the movement of the parent vehicle. In so doing, the parent vehicle does not translate following an ideal straight line but follows a wavy line (with depressions and inclines) along the direction of translation.

It follows that the laser, which is integral and rigid with respect to the parent vehicle, undergoes the vacillation of the rises and descents of the track and, therefore, instead of detecting the orthogonal distance with respect to the reflector, detects the hypotenuse generated by the tilt.

By detecting the hypotenuse instead of the cathetus, the measurement is biased and the parent vehicle is not positioned along the transfer aisle with the desired precision. Furthermore, with very long aisles, the beam line generated by the tilt sets the most extreme point of the laser beam outside the normal reflectors (higher or lower as applicable), invalidating the reading.

### Solution of the Invention

The present invention therefore aims to remedy the aforementioned drawbacks relating to the prior art.

In particular, one object of the present invention is to provide a parent vehicle for moving a load in a warehouse which is capable of improving the accuracy of positioning the parent vehicle in the transfer aisle, without sacrificing the speed features of the systems of the prior art.

The aforesaid object is achieved by a parent vehicle, by a detection method of a relative position of a parent vehicle, and by an automated warehouse according to the attached independent claims. The dependent claims describe preferred embodiments.

### DESCRIPTION OF THE DRAWINGS

The features and advantages of the parent vehicle, the method for detecting a relative position, and the automated warehouse according to the present invention will be evident from the description below of some preferred embodiment examples, given as an indication and without limitation, with reference to the attached figures, wherein:

FIG. 1 is a perspective view of an automated warehouse for storing loads, for example pallets, according to an embodiment of the present invention;

FIG. 1a is a perspective view of a portion of an automated warehouse according to an embodiment of the present invention, wherein a parent vehicle according to an embodiment of the present invention houses a load and a satellite vehicle in its parent vehicle seat and is positioned on a transfer aisle;

FIG. 2 is a planar view of FIG. 1a;

FIG. 3 is the same perspective view of a portion of an automated warehouse of FIG. 1a wherein the load and the satellite vehicle are not on board the parent vehicle, i.e. are not housed in the parent vehicle seat, for example in an unloading step of the load or in a loading step;

FIG. 4 is a plan view from above of FIG. 3;

FIG. 5 is an axonometric view of a parent vehicle according to an embodiment of the present invention;

FIG. 6 is a planar elevation view of the parent vehicle in FIG. 5;

FIG. 7 is a sectional view along the sectional plane C-C of FIG. 6;

FIG. 8 is an axonometric view of a distance detector assembly according to an embodiment of the present invention;

FIG. 9 is a front planar view of the distance detector assembly of FIG. 8;

FIG. 10 is a sectional view of the distance detector assembly in FIG. 8;

### DETAILED DESCRIPTION

While the present invention is described below with reference to preferred embodiments shown in the drawings, the present invention is not limited to the embodiments described below and shown in the drawings. On the contrary, the described and represented embodiments clarify some aspects of the present invention.

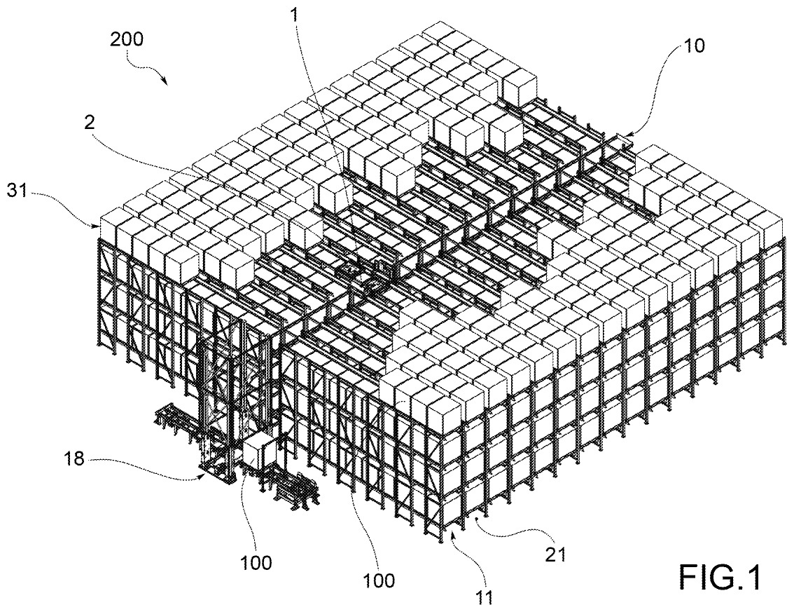

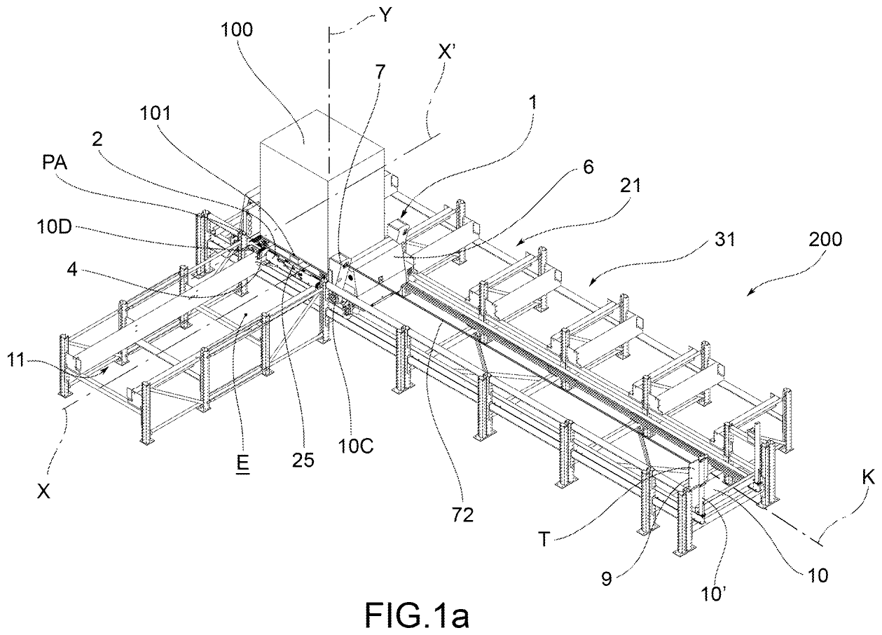

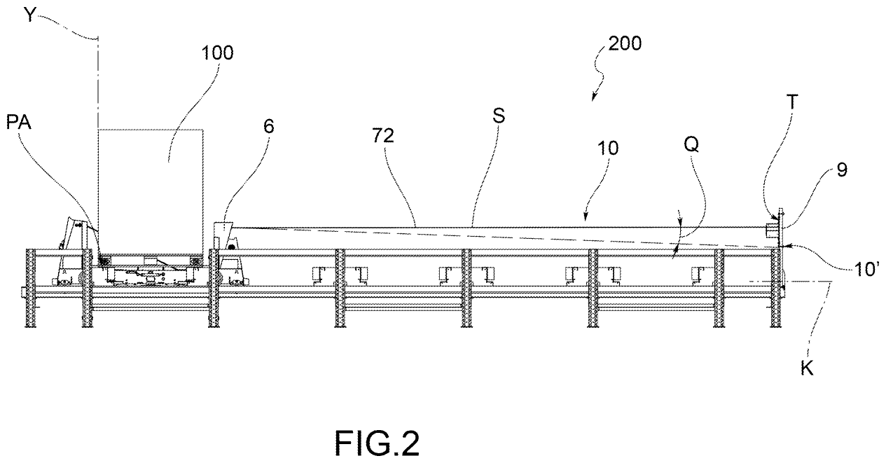

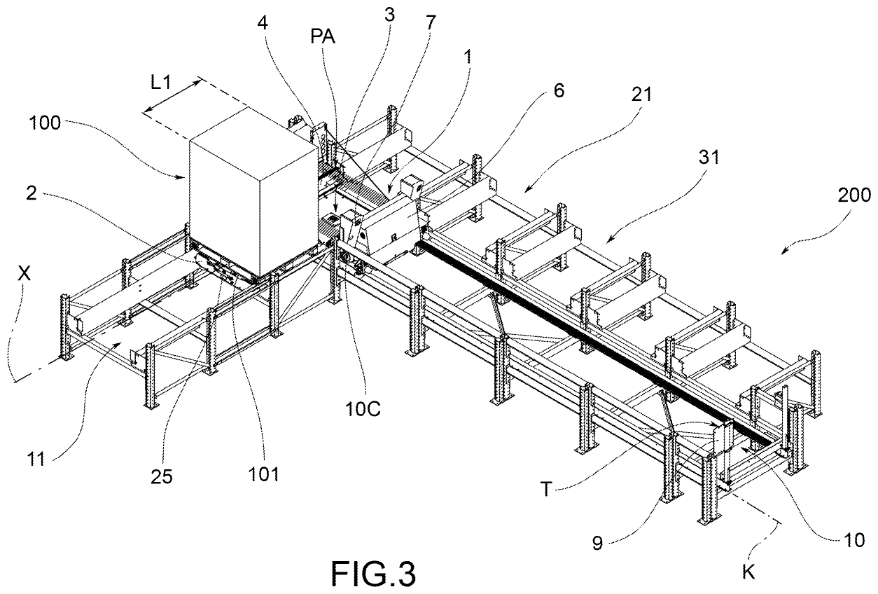

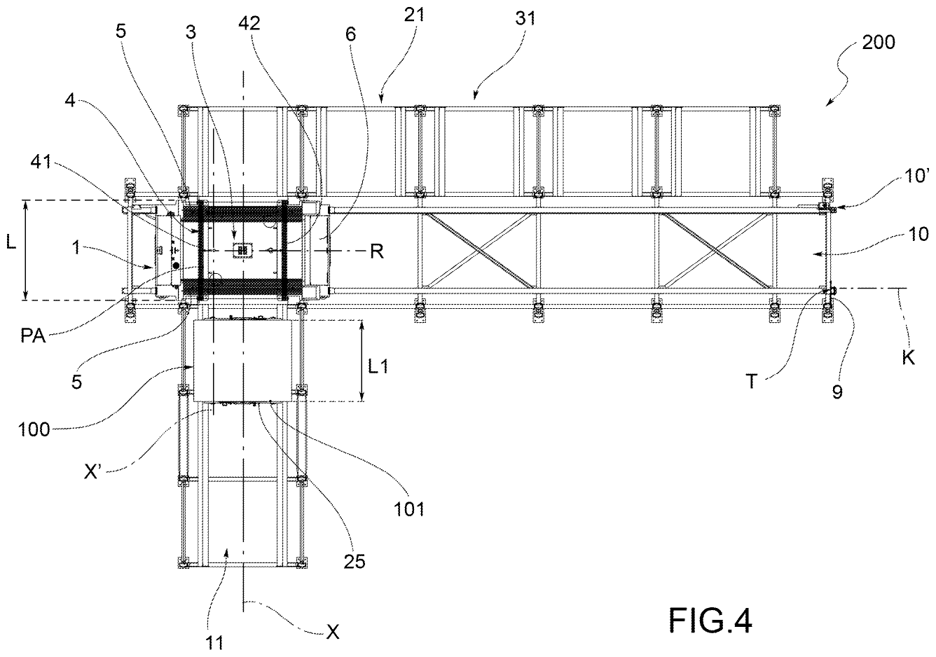

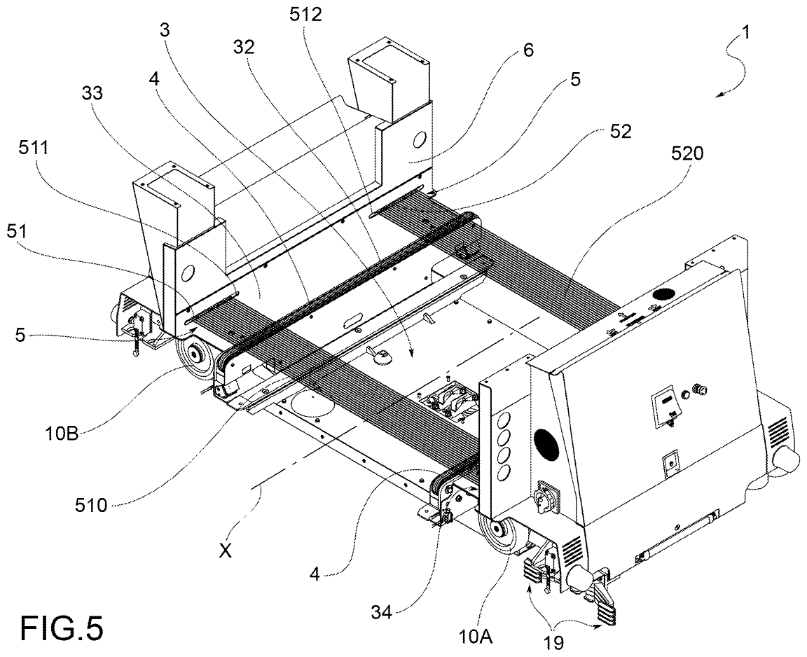

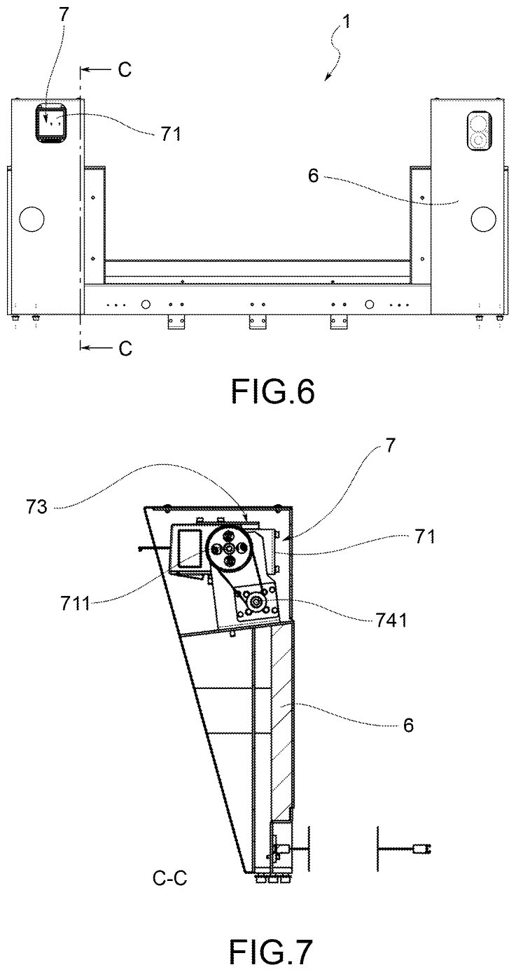

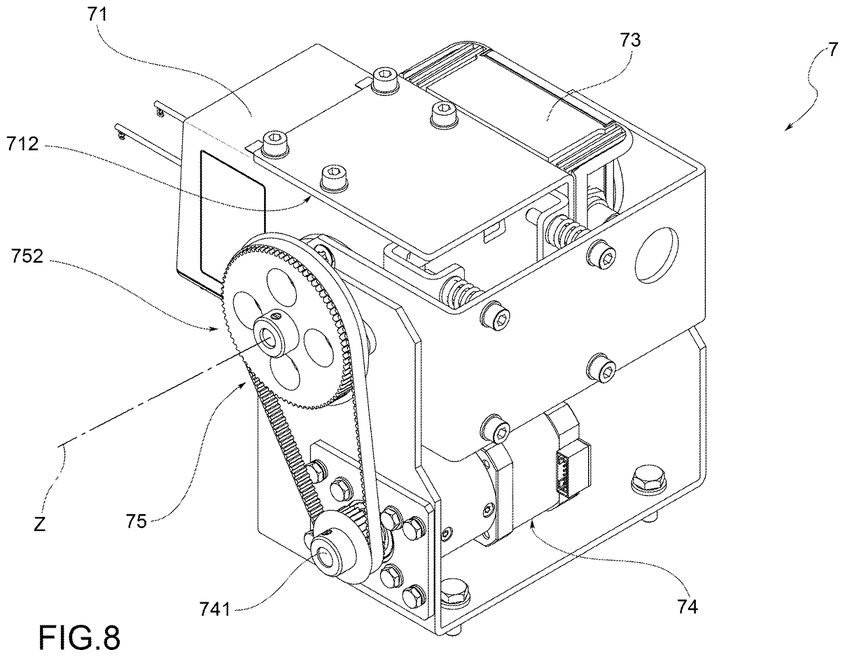

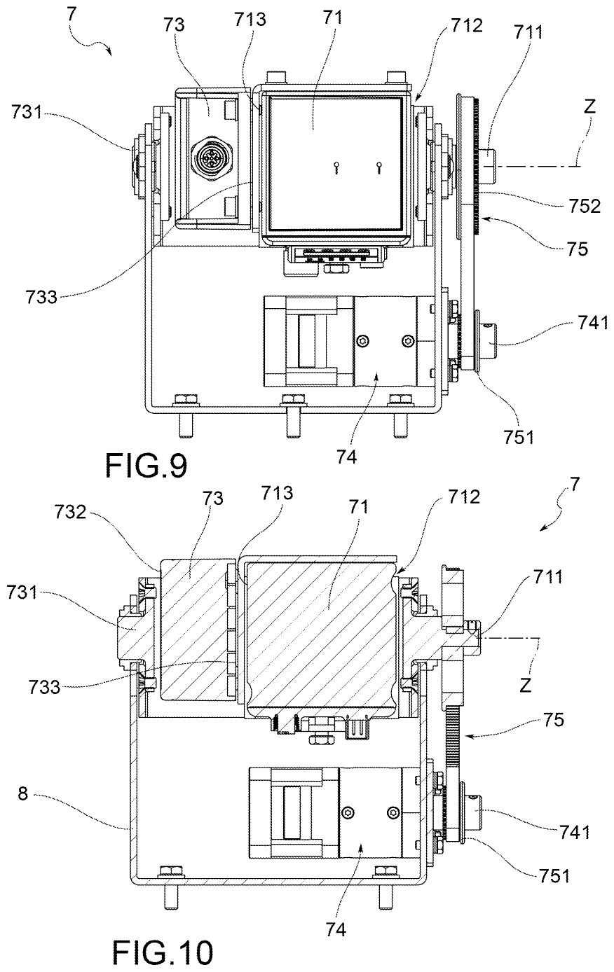

FIG. 1 schematically shows a warehouse 200 for storing loads 100, typically pallets, comprising a parent vehicle 1 according to a preferred embodiment of the invention.

The warehouse 200 shown in the figures by way of example has a simple layout and preferably comprises storage aisles 11, 21, 31 arranged laterally with respect to a central transfer aisle 10.

The warehouse 200 also preferably comprises a loading/unloading station 18 for the loads, or an area on which a load 100 which must be stored in a predetermined compartment of the warehouse 200 is placed, or an area on which a load taken from a compartment of the warehouse 200 is placed.

The movement of a load 100 inside the warehouse 200 is advantageously carried out by the parent vehicle 1 according to the invention, together with a satellite vehicle 2, also shown.

The movement of the load 100 in the warehouse 200 consists, preferably, in moving said load from the loading/unloading station 18 towards and into the aisles 11, 21, 31.

The parent vehicle 1 according to the invention preferably allows the movement of loads of large dimensions and weights, such as pallets, but other types of items are not excluded.

The parent vehicle 1 according to the invention is therefore particularly suitable for moving pallets containing items for automatically storing the load 100 in a warehouse 200.

The parent vehicle 1 according to the invention is therefore suitable for transporting a satellite vehicle 2 for automatically storing a load 100, for example a pallet, in a warehouse 200 as previously described, for example a warehouse comprising storage aisles 11, 21, 31 for the load 100, mutually parallel and arranged on multiple levels, and at least one transfer aisle 10 arranged in an either incident or perpendicular direction with respect to the storage aisles 11, 21, 31.

The satellite vehicle 2 comprises a vehicle frame on which wheels suitable for allowing the translation of the satellite vehicle along a storage aisle 11, 21, 31 of the warehouse 200 are rotatably connected. First handling means are operatively connected to one or more of said wheels to achieve the translation of the satellite vehicle 2. Furthermore, the satellite vehicle 2 comprises one or more operative portions defining a temporary support surface for the load 100 and second handling means arranged inside the frame and operatively connected to these operative portions, for example a pair of bars, to move them relative to the frame between a base position and a lifting position, spaced vertically with respect to the base position, so as to load the load by picking it up from the parent vehicle 1.

Preferably, the satellite vehicle 2 comprises main power supply means, for example a battery or a supercapacitor, mounted on said device so as to make the device autonomous and self-powered and rechargeable by said parent vehicle 1 when arranged on board the parent vehicle 1.

According to an embodiment, a central control unit integrally associated with the frame of the satellite vehicle 2 controls all moving parts of the satellite vehicle and the communication with the sensors.

The parent vehicle 1 comprises a base frame 6, for example having a shape that in vertical section is similar to a U or a C rotated by 90°, onto which wheels 10A, 10B, 10C, 10D suitable for allowing the translation of the parent vehicle 1 along the transfer aisle 10 of the warehouse 200 are rotatably connected.

The parent vehicle 1 also comprises a first actuator, for example an electrical motor and an electric power source, arranged inside said base frame 6 and operatively connected to one or more of said wheels 10A, 10B, 10C, 10D to achieve the translation of the parent vehicle 1.

According to an embodiment, the electrical power source comprises a cable or connector, connected to a skid device. This skid device 19 is suitable for making electrical contact with one or more electrified rails which make up the transfer aisle 10 or which are installed on the transfer aisle 10. For example, the skid device 19 is configured to slide in contact with one or more of said electrified rails.

The wheels 10A, 10B, 10C, 10D are therefore suitable for allowing the translation of the parent vehicle 1 along a transfer direction K in the transfer aisle 10.

The parent vehicle 1 further comprises a parent vehicle seat 3 suitable for transporting the load 100 and the satellite vehicle 2 and comprises a support surface PA for the load 100.

According to the invention, the parent vehicle 1 comprises a distance detector assembly 7 comprising a laser device 71 configured to emit a laser beam 72 and detect the time of flight of said laser beam to generate a distance signal with respect to a reference point T on the transfer aisle. This laser device 71 is mounted on the parent vehicle 1 in a relatively movable manner with respect to the base frame 6.

Furthermore, the distance detector assembly 7 also comprises a tilt detection device 73 and a laser device actuator 74 operatively connected to the laser device 71 to move the laser device 71.

The parent vehicle 1 also comprises an electronic processing unit, configured to receive a parent vehicle tilt signal from the tilt detection device 73 and to generate a control signal for the laser device actuator 74 to move the laser device 71 with respect to the base frame 6 so as to compensate for the tilt of the parent vehicle 1 detected by the tilt detection device 73 as a function of the parent vehicle tilt signal received. This makes it possible to compensate for variations in the tilt of the parent vehicle along the tracks of the transfer aisle due to the non-perfect planar alignment of said tracks.

According to an embodiment, the laser device 71 is mounted on the parent vehicle 1 in a relatively rotatable manner with respect to the base frame 6 about a device rotation axis Z parallel to the support surface PA and perpendicular to the transfer direction K.

Preferably, the laser device actuator 74 is an electric motor.

According to an embodiment, the laser device 71 is connected to a drive shaft 741 of the electric motor by means of a transmission system 75, preferably a reduction gear 751 and a belt transmission system 752, or a transmission system 75 comprising a chain or comprising a cascade of gears.

According to an embodiment, the laser device 71 is connected directly to the drive shaft 741 of the electric motor.

According to an embodiment, the laser device 71 and the tilt detection device 73 are integrally connected to each other, i.e. they are integrally moved by the laser device actuator 74. This allows a compact system to be obtained and facilitates the processing of the control signal to be generated on the electronic processing unit.

According to an embodiment, the laser device 71 is rotatably supported by a device pin 711 arranged on the rotation axis Z and operatively connected to the drive shaft 741 to be driven in motion.

Preferably, the laser device 71 is fixed to the device pin 711 at a first side 712 thereof and to the tilt detection device 73 at a second side 713 thereof, opposite to the first side 712 along the rotation axis Z.

Preferably, the tilt detection device 73 is idly supported on an tilt device pin 731 on one side 732 thereof opposite to one device side 733 thereof joined to the second side 713 of the laser device 71.

According to an embodiment, the parent vehicle 1 comprises a support frame 8, fixed to the base frame 6 to be spaced apart from the support surface PA along a vertical direction Y perpendicular to the support surface. The laser device actuator 74 is mounted to the support frame 8, preferably to be spaced apart from the laser device 71 along the vertical direction Y. Furthermore, preferably, the device pin 711 and the tilt device pin 731 are supported directly by the support frame 8.

As mentioned above, a subject matter of the present invention is also an automated warehouse 200 comprising a parent vehicle 1 according to any one of the embodiments described above and a reflector element 9 fixed to a transfer aisle 10 suitable for reflecting the laser from the laser device 71 of the parent vehicle 1.

Preferably, the reflector element 9 is fixed to a head 10′ or tail portion of the transfer aisle 10, for example it is a reflector panel having a reflective face arranged perpendicular to the transfer direction K.

A subject matter of the present invention per se is likewise a method for detecting a relative position of a parent vehicle 1 according to any of the previously described embodiments. The method comprises the following operative steps:
a. during the translation of the parent vehicle in a transfer aisle 10 of a warehouse 200, by means of the tilt detection device 7, detecting a current parent vehicle tilt signal, indicative of a change in the tilt Q of the parent vehicle with respect to a reference tilt or reference attitude S;
b. generating a control signal for the laser device actuator 74 according to the current parent vehicle tilt signal;
c. during the translation of the parent vehicle 1, by means of said control signal, moving the laser device actuator 74 to compensate for the tilt change, so as to maintain a laser beam 72 of the laser device 71 parallel to the reference tilt s.

According to an embodiment, the method comprises an initialization step in which the parent vehicle 1 is caused to slide over the whole extension of the transfer aisle 10, and during the travel, the tilt signal detected by the tilt device as a function of each position taken by the parent vehicle 1 along the transfer aisle is stored on a storage device. In this way, a stored tilt signal is obtained as a function of each position of the parent vehicle along the whole transfer aisle. This makes it possible to obtain a signal that is indicative of the quality of the tracks of the transfer aisle at each point of the aisle, with the resulting possibility of having a step of the method for generating an alarm signal from the electronic processing unit for a given position in the event that a predefined threshold tilt is exceeded.

According to an embodiment, the method also comprises the step of processing or comparing the current parent vehicle tilt signal detected by the tilt device 7 at a given position during the translation of the parent vehicle 1 with the tilt signal stored in the initialization step at the Same given position and calculating a signal indicative of a discrepancy between the stored tilt signal and the current tilt signal. This makes it possible to maintain the tilt changes of the tracks of the aisle over time up to date and also to update the processing of the current tilt signal and the calculation strategy of the control signal for the laser device actuator 74.

According to an embodiment, during the translation of the parent vehicle, the stored tilt signal is processed in the electronic processing unit to calculate, in a predictive manner, a control signal for the laser device actuator 74 at a given translation position of the parent vehicle before the parent vehicle 1 reaches said given translation position. This makes it possible to generate a command for the actuator that is able to anticipate in a predictive manner the amount of tilt correction to be made to the laser device at a certain position along the aisle, also as a function of the speed or acceleration of travel of the transfer aisle by the parent vehicle, further improving the precision and measurement accuracy of the position.

According to an embodiment, the parent vehicle comprises at least one optoelectronic device 5, for example a laser beam light barrier 51 (for example laser beams produced by a certain light frequency, e.g., red or infrared or other frequencies) or a non-visible, non-contact electromagnetic radiation optoelectronic device, configured to generate a load detection signal, identifying the relative position of the load 100 inside the parent vehicle seat 3.

According to an embodiment, the electronic processing unit is configured to receive the load detection signal and process said signal to calculate a relative distance of the load 100 with respect to a physical reference of the parent vehicle 1, for example with respect to a central axis R of the parent vehicle seat 3 positioned on the centerline of the extension L of the parent vehicle seat 3 in the load transporting direction X.

Preferably, the electronic processing unit is also configured to communicate with a warehouse management unit on which a warehouse software program manages the operation of the warehouse 200 and in particular the movements of the parent vehicle 2 within the warehouse 200. The communication between the electronic processing unit and the warehouse management unit is preferably wireless communication.

According to an embodiment, the optoelectronic device 5 comprises a first laser beam light barrier 51, comprising a plurality of laser beams mutually spaced apart along the load transporting direction X and arranged transversely with respect to the load transporting direction X in the parent vehicle seat 3, said first laser beam light barrier 51 being configured to generate the load detection signal as a function of the number of laser beams interrupted by the load 100 when it is inserted into the parent vehicle seat 3. This allows for a measurement of the relative position of the load 100, for example the base of the pallet, within the parent vehicle seat 3 to be obtained precisely and accurately and independently of the specific size of the load.

According to an embodiment, the first laser beam light barrier 51 extends along the entire length of the parent vehicle seat 3 in the load transporting direction X.

According to an alternative embodiment, shown for example in the accompanying figures, the optoelectronic device 5 comprises at least a first laser beam light barrier 51 and a second laser beam light barrier 52 mutually spaced apart along the load transporting direction X. Each of said first and second laser beam light barriers 51, 52 comprises a respective plurality of laser beams 510, 520 mutually spaced apart along the load transporting direction X and arranged transversely with respect to the load transporting direction X in the parent vehicle seat 3. Furthermore, each of said first 51 and second laser beam light barriers 52 is configured to generate the load detection signal as a function of the number of laser beams interrupted by the load 100 in both the first 51 and in the second laser beam light barrier 52. This makes it possible to detect the beginning and the end of the load 100 in an optimized, redundant, and resource-saving manner with respect to the variant with a single laser beam light barrier.

According to an embodiment, the electronic processing unit is further configured to process the load detection signal to calculate a load length L1 relative to the load extension length along a loading direction X′ parallel to the load transporting direction X. In this way, with the extension length of the load known, it is possible to calculate the distance to be traveled by the transporting device 4 to be centered with respect to the parent vehicle seat 3 or to be correctly moved when it is to be picked up from the satellite vehicle 2.

Preferably, the electronic processing unit is configured to compare said load length L1 with a predetermined load length value previously stored in an electronic storage unit. In this way it is possible to determine the type of load, for example a pallet, loaded.

According to an embodiment, the parent vehicle seat 3 comprises a support surface 32, suitable for receiving the load 100 resting thereon, a first vertical wall 33 extending along a perpendicular direction Y to the support surface 32, and a second vertical wall 34, parallel to the first vertical wall 33 and arranged to be spaced apart from and opposite to said first vertical wall 33. Preferably, a laser beam emitting device 511, 512 of each of the first and second laser beam light barriers 51, 52 is fixed on the first wall 33 and a laser beam reflecting or receiving device 521, 522 of each of the first and second laser beam light barriers 51, 52 is fixed on the second vertical wall 34.

Preferably, each laser beam emitting device 511, 512 of each of the first and second laser beam light barriers is fixed close to the support surface 32 and spaced apart from the support surface 32 such that the laser beams of each emitting device are less than fifteen centimeters away from the support surface 32. This makes it possible to correctly measure the size of the base of the pallet and avoid measuring the object or objects arranged on the base of the pallet.

A person skilled in the art will understand that the additional technical features of the parent or satellite vehicle not specifically described in this discussion are known to a person skilled in the art, both by the already known commercial vehicles in circulation and at least by the entire description of document WO2012127419A1, the content of which is intended to be included herein.

Furthermore, a person skilled in the art will understand that the present invention refers also per se to the distance detector assembly 7 comprising a laser device 71 configured to emit a laser beam 72 and detect the time of flight of said laser beam to generate a distance signal with respect to a reference point T on a warehouse transfer aisle 200. This laser device 71 is therefore suitable for being mounted on a parent vehicle 1 in a relatively movable manner with respect to a base frame 6 of the parent vehicle 1. This distance detector assembly 7 also comprises a tilt detection device 73 and a laser device actuator 74 operatively connected to the laser device 71 to move said laser device 71. The laser device actuator 74 is thus configured to receive a control signal to move the laser device 71 with respect to the base frame 6 so as to compensate for any tilt of the parent vehicle 1 detected by the tilt detection device 73.

It is also clear that all of the technical features described in the preceding paragraphs of the present document that refer to the distance detector assembly 7 or the laser device 71 or the tilt detection device 73 or the laser device actuator 74 may be attributed per se to the distance detector assembly 7 independently of the parent vehicle 1. Furthermore, it is also clear that the support frame 8, previously described as forming part of the parent vehicle 1, may also be part per se of the distance detector assembly 7. This is because, preferably, this frame 8 is suitable for being directly fixed to the base frame 6 of the parent vehicle 1. Furthermore, preferably, the laser device actuator 74 is mounted on said support frame 8. Furthermore, as already described, preferably, the device pin 711 and the tilt device pin 731 are supported directly by the support frame 8.

Innovatively, by virtue of the presence of the distance detector assembly, the present invention allows a load to be transported within an automated warehouse, improving the positioning accuracy and precision of the parent vehicle, and reducing the downtime due to the maintenance and re-calibration of each vehicle as a function of the aisle in which it is working.

Furthermore, the present invention makes it possible to reduce the operator's requests for intervention to adjust the incorrect positioning and thus the overall efficiency of the warehouse.

Furthermore, in an innovative way, the invention allows for increased speeds and accelerations in the positioning of the parent vehicle, precisely by virtue of the assembly of the laser directly on board the machine and the active compensation of the tilt also due to accelerations.

Furthermore, by virtue of the presence of the tilt compensation, it is possible to reduce the size of the reflector element positioned on the aisle with consequent ease and increased versatility in positioning the reflector in the warehouse.

Furthermore, due to the possibility of recording the tilt of the parent vehicle along the entire aisle, it is possible to provide for and prevent any maintenance interventions on the shelf.

It is clear that a person skilled in the art may make changes to the invention in order to meet contingent needs, said changes all falling within the scope of protection as defined in the following claims.

1. A parent vehicle for transporting a satellite vehicle for automatically storing a load in a warehouse comprising storage aisles for the load mutually parallel and arranged on multiple levels, and at least one transfer aisle arranged in an either incident or perpendicular direction with respect to the storage aisles, the parent vehicle comprising:
a base frame onto which wheels suitable for allowing a translation of the parent vehicle along a transfer direction of the at least one transfer aisle are rotatably connected;
a first actuator arranged inside the base frame and operatively connected to one or more of the wheels to achieve the translation of the parent vehicle,
a parent vehicle seat suitable for transporting the load and the satellite vehicle and comprising a support surface for the load;
wherein the parent vehicle further comprises a distance detector assembly comprising a laser device configured to emit a laser beam and detect a time of flight of the laser beam to generate a distance signal with respect to a reference point on the at least one transfer aisle, the laser device being mounted to the parent vehicle in a relatively movable manner with respect to the base frame;
wherein the distance detector assembly further comprises a tilt detection device and a laser device actuator operatively connected to the laser device to move the laser device; and
wherein the parent vehicle still further comprises an electronic processing unit configured to receive a parent vehicle tilt signal from the tilt detection device and to generate a control signal for the laser device actuator to move the laser device with respect to the base frame to compensate for a tilt of the parent vehicle detected by the tilt detection device as a function of the parent vehicle tilt signal received.

2. The parent vehicle of claim 1, wherein the laser device is mounted to the parent vehicle in a relatively rotatable manner with respect to the base frame about a rotation axis parallel to the support surface and perpendicular to the transfer direction.

3. The parent vehicle of claim 1, wherein the laser device actuator is an electric motor, and wherein the laser device is connected to a drive shaft of the electric motor by a transmission system.

4. The parent vehicle of claim 1, wherein the laser device and the tilt detection device are integrally connected to each other and integrally moved by the laser device actuator.

5. The parent vehicle of claim 3, wherein the laser device is rotatably supported by a device pin arranged on a rotation axis and operatively connected to the drive shaft to be driven in motion by the drive shaft.

6. The parent vehicle of claim 5, wherein the laser device is fixed to the device pin at a first side thereof and to the tilt detection device at a second side thereof, opposite to the first side along the rotation axis, and wherein the tilt detection device is idly supported on a tilt device pin on one side thereof opposite to one device side thereof joined to the second side of the laser device.

7. The parent vehicle of claim 6, further comprising a support frame, fixed to the base frame to be spaced apart from the support surface along a vertical direction perpendicular to the support surface, wherein the laser device actuator is mounted to the support frame.

8. An automated warehouse comprising the parent vehicle of claim 1, and a reflector element fixed to the at least one transfer aisle and suitable for reflecting a laser from the laser device of the parent vehicle.

9. A method of detecting a relative position of a parent vehicle for transporting a satellite vehicle for automatically storing a load in a warehouse comprising storage aisles for the load, mutually parallel and arranged on multiple levels, and at least one transfer aisle arranged in an either incident or perpendicular direction with respect to the storage aisles, the parent vehicle comprising:
a base frame onto which wheels suitable for allowing a translation of the parent vehicle along a transfer direction of the at least one transfer aisle are rotatably connected;
a first actuator arranged inside the base frame and operatively connected to one or more of the wheels to achieve the translation of the parent vehicle,
a parent vehicle seat suitable for transporting the load and the satellite vehicle and comprising a support surface for the load;
wherein the parent vehicle further comprises a distance detector assembly comprising a laser device configured to emit a laser beam and detect a time of flight of the laser beam to generate a distance signal with respect to a reference point on the at least one transfer aisle, the laser device being mounted to the parent vehicle in a relatively movable manner with respect to the base frame;
wherein the distance detector assembly further comprises a tilt detection device and a laser device actuator operatively connected to the laser device to move the laser device; and
wherein the parent vehicle still further comprises an electronic processing unit configured to receive a parent vehicle tilt signal from the tilt detection device and to generate a control signal for the laser device actuator to move the laser device with respect to the base frame to compensate for a tilt of the parent vehicle detected by the tilt detection device as a function of the parent vehicle tilt signal received, the method comprising the following operating steps:
(a) during the translation of the parent vehicle in the at least one transfer aisle by the tilt detection device detecting a current parent vehicle tilt signal, indicative of a change in the tilt of the parent vehicle with respect to a reference tilt;
(b) generating the control signal for the laser device actuator as a function of the current parent vehicle tilt signal; and
(c) during the translation of the parent vehicle by the control signal, moving the laser device actuator to compensate for the tilt change, so as to maintain the laser beam of the laser device parallel to the reference tilt.

10. The method of claim 9, comprising an initialization step in which the parent vehicle is caused to slide over a whole extension of the at least one transfer aisle and during travel, a tilt signal detected by the tilt detection device as a function of each position taken by the parent vehicle along the at least one transfer aisle is stored on a storage device, thus obtaining a stored tilt signal as a function of each position of the parent vehicle along the at least one transfer aisle.

11. The method of claim 10, further comprising a step of processing or comparing the current parent vehicle tilt signal detected by the tilt detection device at a given position during the translation of the parent vehicle with the tilt signal stored in the initialization step at a same given position and calculating a signal indicative of a discrepancy between the stored tilt signal and the current parent vehicle tilt signal.

12. The method of claim 10, wherein, during the translation of the parent vehicle, the stored tilt signal is processed in the electronic processing unit to predictively calculate the control signal for the laser device actuator at a given translation position of the parent vehicle before the parent vehicle reaches the given translation position.

13. A distance detector assembly comprising:
a laser device configured to emit a laser beam and detect a time of flight of the laser beam to generate a distance signal with respect to a reference point on a transfer aisle of a warehouse the laser device being suitable for being mounted to a parent vehicle in a relatively movable manner with respect to a base frame of the parent vehicle; and
a tilt detection device and a laser device actuator operatively connected to the laser device to move the laser device the laser device actuator being configured to receive a control signal to move the laser device with respect to the base frame so as to compensate for any tilt of the parent vehicle detected by the tilt detection device.

14. The parent vehicle of claim 1, wherein the load is a pallet.

15. The parent vehicle of claim 1, wherein the first actuator is an electric motor and an electric power source.

16. The parent vehicle of claim 3, wherein the laser device is connected to the drive shaft of the electric motor by a reduction gear and a belt transmission system.

17. The parent vehicle of claim 7, wherein the laser device actuator is mounted to the support frame to be spaced apart from the laser device along the vertical direction.

18. The parent vehicle of claim 7, wherein the device pin and the tilt device pin are also supported by the support frame.

19. The method of claim 9, wherein the load is a pallet.

20. The method of claim 9, wherein the first actuator is an electric motor and an electric power source.
